(19) United States
(12) Patent Application Publication
(10) Pub. No.: US 2014/0020112 A1
(43) Pub. Date: Jan. 16, 2014

(54) Method of Securing Memory Against Malicious Attack

(71) Applicant: Grant Stewart Goodes, Ottawa (CA)

(72) Inventor: Grant Stewart Goodes, Ottawa (CA)

(73) Assignee: IRDETO B.V., Hoofddorp (NL)

(21) Appl. No.: 14/007,475

(22) PCT Filed: Mar. 30, 2011
(86) PCT No.: PCT/CA2011/050167

§ 371 Date: Sep. 25, 2013

(51) Int. Cl. G06F 21/78

(52) U.S. Cl. CPC G06F 21/78
USPC 726/26

(57) ABSTRACT

A method and system for secure dynamic memory management using heap memory, or analogous dynamic memory allocation, that includes initializing a heap memory segment, having a plurality of buffers, within a random access memory. When an allocation request to store data in the heap memory segment is received, one of the buffers is randomly selected. Metadata, containing details of allocated and unallocated buffers of the heap memory segment, is then maintained in a portion of the memory separate from the heap object. According to certain embodiments, the secure heap of the present disclosure can securely implement the functions of those portions of the C/C++ stdlib library related to dynamic memory management, specifically malloc ( ) free ( ) and their variants.

### FIELD OF THE INVENTION

The present disclosure is directed to methods and systems for protecting software from malicious attack. In particular, the present disclosure is directed to a method and system for protecting dynamically-allocated storage of an application.

### BACKGROUND OF THE INVENTION

A software application consists of data and code that manipulates this data in order to process the inputs to the application and produce some outputs. The data is used to keep track of the internal state of the application during its execution. Some of the data has a constant value which typically is embedded in the code of the application. Data with variable values is generally stored in a random access memory.

Some of the variables can be allocated to a memory location during compile time. Most data, however, is dependent on the execution flow of the application, so the required memory resources need to be allocated dynamically. An example is the exchange of the parameters between function (procedure) calls. These parameters are often kept in a stack, which is a popular memory allocation structure for passing parameters between functions. The memory allocation for the stack is determined fully by the calling sequence of the functions.

In other cases, the application itself controls the dynamic memory allocation for certain data and thus is responsible for the entire lifecycle of the dynamically allocated memory resources. Dynamic memory allocation, also known as heap-based memory allocation, is the allocation of memory storage for use by an application during the runtime of that application. The dynamic memory allocation often is implemented using standard functions in a particular programming language environment. Such functions are commonly supported by a programming language specific library, such as the C/C++ stdlib. The library implemented functions in turn request the memory resources from the operating system.

Dynamic memory allocation functions also can form an integral part of the runtime environment of the programming language. In that case, automatic memory management is implemented in the runtime execution environment. For some of these languages, the execution environment can use standard memory allocation libraries of another programming language.

Dynamic memory data are vulnerable to attacks that leverage the predictable behaviour of the allocated memory. The dynamic memory implementations often have few (if any) checks on the data integrity. In some applications, some inputs may compromise the integrity of the data structures in the dynamically allocated memory (i.e., when the size of an input is larger than the allocated buffer in the dynamic memory). Knowledge of the physical location of dynamic memory allocations can assist an attacker in extending a data integrity weakness into a successful attack that can take full control over the operations of the application.

A way to mitigate these attacks is the use of a technique called Address Space Layout Randomization (ASLR), which modifies the base address of the entire heap at system startup, typically to one of a handful of possible values. The heap behaviour is still fully deterministic, but all allocation addresses are shifted in memory by the differing base addresses. ASLR prevents relatively simple, robotic attacks that assume the allocation address is exactly a constant value. The ASLR technique needs to be implemented by the Operating System that supports the execution of the application.

In a whitebox attack context, where an attacker has full control over the execution environment and the software implementation unless the computing device is physically secured, the attacker has access to the code, the data structures and the execution environment. The protection of the dynamically allocated storage is an important security concern for such software applications. Known protection techniques for dynamic memory allocation schemes rely on the operating system and the virtual memory hardware and do not prevent a smart attack that compensates for the differing base addresses. In addition, some processor hardware and some operating systems do not have the ability to support a protection scheme for dynamically allocated memory.

In addition, no current scheme provides full protection of the heap metadata. The heap metadata describes the amount and location of unallocated (free) memory in the heap, and sufficient information to allow freeing of an allocated buffer, based only on the allocation address. It is normally completely invisible to the user, at least from a heap API perspective, but is often vulnerable to reverse-engineering, since the goal is usually performance rather than security. More advanced protection of dynamically allocated storage, such as checksums, encryption, non-contiguous allocations, etc., is not supported at all.

It is therefore desirable to protect the dynamically allocated storage of an application by providing a secured implementation of the standard dynamic memory management functions.

### SUMMARY OF THE INVENTION

There is provided a computer-implemented method of dynamic memory management. The method comprises initializing a heap memory segment, having a plurality of buffers, within a memory. When an allocation request to store data in the heap memory segment is received, at least one of the plurality of buffers satisfying the allocation request is non-deterministically selected as an allocated buffer for the data. Metadata relating to the allocated buffer is maintained in a portion of the memory separate from the heap memory segment. The data is then associated to the non-deterministically selected buffer. A non-transitory computer-readable medium containing instructions, which when executed by a processor cause the processor to perform the method of dynamic memory management is also provided.

According to embodiments, the heap memory segment can be initialized by dividing the heap memory segment into a plurality of pages of fixed size. The non-deterministic selection of a buffer can comprise generating a permutation of the plurality of pages, and selecting a next free page from the permutation of the plurality of pages that satisfies the allocation request, or generating a permutation of the plurality of buffers, and selecting a next free buffer from the permutation of the plurality of buffers that satisfies the allocation request. The metadata can include details of allocated and unallocated buffers of the heap memory segment, which can be used to implement integrity verification. The metadata can include a pointer to the allocated buffer, such as an opaque pointer that cannot be directly de-referenced by the application. The metadata can also include attributes of individual allocations, such as details of security transformations, such as encryption details, applied to the data. The method can further comprise receiving a free request to free one or more of the plurality of buffers; and applying a free policy to the one or more of the plurality of buffers. The free policy can, for example, determine whether to scramble or zero data in the one or more of the plurality of buffers.

### BRIEF DESCRIPTION OF THE DRAWINGS

Embodiments of the present disclosure will now be described, by way of example only, with reference to the attached Figures.

FIG. 1 is a diagram of a computing environment for implementing dynamic memory management using secure heaps according to an embodiment of the present disclosure.

FIG. 2 is a flowchart of a method for dynamic memory management using secure heaps according to an embodiment of the present disclosure.

FIG. 3 is a diagram of a secure heap memory segment according to an embodiment of the present disclosure.

### DETAILED DESCRIPTION

Generally, the present disclosure describes a method and system for secure dynamic memory management. Embodiments are described in relation to C/C++ implementations, but are not intended to be restricted to such implementations, and the method described herein can be used in relation to any dynamic memory management system using heap memory, or analogous dynamic memory allocation. According to certain embodiments, the secure heap of the present disclosure can securely implement the functions of those portions of the C/C++ stdlib library related to dynamic memory management, specifically malloc( ), free( ) and their variants.

Broadly speaking, the secure heap implementation supports two types of memory allocation pointers: “smooth” and “handle” pointers. The “smooth” pointers are standard memory addresses pointing to a piece of storage with the requested size. “Smooth” pointers may be directly dereferenced by the calling application. The “handle” pointers are not standard memory addresses, and thus cannot be directly de-referenced by the calling application. They are used to support some of the more advanced secure heap features, such as non-contiguous array allocation, and require the use of memory-access APIs for all references to the allocated storage in the user application.

One of the more critical vulnerabilities of using the standard dynamic memory management implementation is that it is outside of the transcoding domain, and thus must maintain a smooth API. For example, calls to malloc( ) and free( ), including such key parameters as the size of a requested allocation, and the returned allocation address, are not candidates for transformation by a transcoder. It is trivial for an attacker to identify all locations in the application where user-data is allocated, and simple techniques, such as the use of debuggers, etc., can be used to pinpoint an allocation request of a specific size of interest, for example, the key-size in a crypto-application. Unless the memory management library can be brought into the transcoding domain, attackers can detect sensitive user-data allocation and initialization code. As used herein, the “transcoding domain” is a domain where randomized, stochastic, or non-deterministic, transformations can be applied to the memory calls and allocations.

A heap is normally implemented as a collection of memory segments of different sizes, making up all of the currently allocated and unallocated storage, together with a complex data-structure (the heap metadata) that describes the state of the heap. In many implementations, the heap metadata is actually part of the heap storage itself, usually a number of bytes preceding the allocation addresses. Since efficiency is usually the primary design criterion for any heap implementation, there are a small number of ways to implement this heap metadata, making it easy for an attacker to determine the state of the heap at any moment, often by examining a single allocated storage buffer. Thus, even in the absence of dynamic attacks such as debuggers, the heap contents are vulnerable to being completely deciphered if a memory snap-shot can be obtained.

Since efficiency is the primary design criterion for standard heap implementations, there is a predictable pattern to the memory allocation addresses returned for any given allocation request. Heaps are designed to strike a balance between raw execution performance and minimum wastage, or fragmentation, of the heap itself. To that end, allocation requests of specific sizes are usually grouped together in predictable ways to ensure that the heap manager can quickly find free sections of memory, and that fragmentation does not become endemic. It is thus possible to predict what allocation address will be returned for a future request of a given size. One way to spoof a heap manager is to artificially request a block of a size the attacker knows the application will need for a particular function, such as its crypto-key buffer, and then immediately free it after recording the returned address. Many heap implementations will preferentially re-use a recently freed memory buffer for the next allocation request of the same size.

Traditional heap implementations are also deterministic. A given sequence of allocate/free operations will always return the same sequence of allocation addresses. Thus, an application may be analyzed to isolate an allocation of interest, and upon re-running, the allocation will receive the same address as before. This simplifies the job of the attacker, since analysis from earlier runs of the application can be re-used in later runs.

A second aspect of this vulnerability is specific to array allocations. The heap, by its very nature, returns a single chunk of memory at a time and thus all elements of an array allocation are inherently contiguous in memory. Conventional heaps cannot support arrays with non-contiguous layout in memory. Non-contiguous layouts of arrays can result in substantial security benefits.

In addition, C/C++ storage may typically be one of three broad classes: statically-allocated global data (anything in program global-scope); dynamically-allocated locals (such as parameter values and local-scope variables), usually allocated on the stack; and application-requested dynamically-allocated data (the heap). Each of these three storage classes is usually allocated within a predictable and easily distinguished memory range. This makes it easy for an attacker to determine the origin of a piece of storage, given only its address.

Since conventional heap allocations are simply pointers, and hence memory addresses, there are also few if any possibilities for providing dynamic protection of the allocated storage. Dynamic protection includes such techniques as occasionally moving the allocated storage to a different location, re-encoding the contents with different data-transforms at different times, etc. It is very difficult, if not impossible, to effectively implement such dynamic protection techniques if an attacker has access to the raw memory address of the allocated storage.

To eliminate or at least reduce some of the drawbacks of conventional dynamic memory management a “secure” heap implementation is described in the present disclosure. As used herein, “secure” means resistant to attack, and is provided through various obfuscation techniques applied to the heap organization and its metadata.

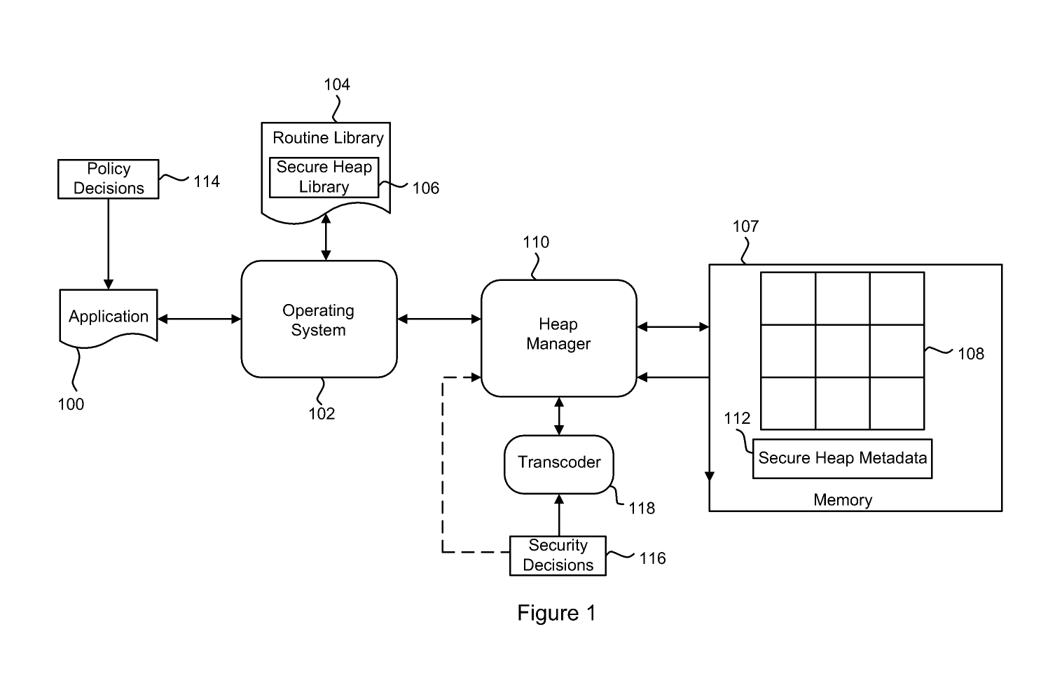

FIG. 1 depicts a computing environment for implementing secure heaps according to an embodiment. The computing environment can be any suitable processor-driven environment, such as a general purpose computer, mobile devices, web servers, set-top boxes, etc. An application 100 executes in the computing environment. An operating system 102 manages the hardware resources of the computing environment, and provides common services for efficient execution of the application 100. The application 100 and the operating system 102 are typically stored in persistent memory (not shown). A runtime library 104 is available to the operating system 102. The runtime library 104 is a library used by the operating system 102 to implement functions built into a programming language during the runtime (execution) of an application. The runtime library 104 will typically include routines, or APIs, to control input/output functions, such as the C/C++ stdio, and commonly implements functions that can be performed only (or are more efficient or accurate) at runtime, such as some error checking, array bounds checking, dynamic type checking, exception handling and debugging. The runtime library 104 also includes secure heap routines, stored as a secure heap library 106, to support secure dynamic memory management according to the present disclosure.

In operation, when the application 100 requires dynamic memory allocation for certain data, this data is stored in a secure heap memory segment 108 within memory 107, such as random access memory. Dynamic memory allocation functions are controlled by a heap manager 110 communicating with the operating system 102. The heap manager 110 manages allocations to the heap memory segment based on policy decisions 114 and security decisions 116 that are provided to it, either directly or indirectly. The heap manager 110 also maintains secure heap metadata 112 that details allocated and unallocated buffers within the heap memory segment 108. The heap metadata 112 may also include other information, such as details of transformations, encryption, etc. applied to the data.

According to an embodiment, the computing environment can also include a transcoder 118, such as the Cloakware Transcoder™. A “transcoder” is an automated tool to apply randomized, stochastic, or non-deterministic, transformations to data and code, including dynamic memory calls and allocations. The functioning of the transcoder 118 is outside the scope of this document, but can generally be understood to apply security transformations to obfuscate or cloak variables and mathematical operations on data, particularly cryptographic operations, to ensure it is not visible to an attacker and does not reveal information damaging to critical assets. The transcoder 118 can also apply control flow transformations to disguise the programmatic flow of the application, making it very difficult for an attacker to statically or dynamically trace the operation of the application. The transcoder 118 can be considered a utility that transforms data, data structures, and source code into mathematically modified data, data structures, and source code. The transformed data, data structures, and source code are functionally identical to the originals but are highly resistant to reverse engineering and tampering attacks.

Security transformations can involve the use of characteristic constants. For example, transformations can involve the use of mathematical mapping functions which transform locations to alternate mathematical spaces, as described in U.S. Pat. No. 6,594,761; TAMPER RESISTANT SOFTWARE ENCODING, issued Jul. 15, 2003 and U.S. Pat. No. 6,842,862; TAMPER RESISTANT SOFTWARE-MASS DATA ENCODING, issued Jan. 11, 2005, the contents of which are incorporated herein by reference in their entirety. In order to do this, the transcoder 118 uses a set of function families and a number of characteristic constants for each mapping. The constants are chosen randomly (and consistently among each other). The set of constants become a distinguishing factor of the library instance and are necessary for the program to function correctly. These constants form part of the heap metadata The precise values of these constants are chosen by the transcoder 118, based on the characteristics of the transformation functions. Moreover, there may be many inter-related security transform constants found throughout the application that have been selected in a mutually consistent manner, so that changing one constant might require changing many of the others in some consistent way.

Examples of data transformation and white-box cryptography implementations can be found in the following patent documents: TAMPER RESISTANT SOFTWARE ENCODING AND ANALYSIS, US Patent Publication 2004/0236955-A1; SOFTWARE CONDITIONAL ACCESS SYSTEM, US Patent Publication 2005/0039025-A1; METHOD AND SYSTEM FOR SECURE ACCESS, U.S. Pat. No. 7,325,141; METHOD AND SYSTEM FOR SUSTAINABLE DIGITAL WATERMARKING, US Patent Publication 2005/0021966 A1; SECURE METHOD AND SYSTEM FOR BIOMETRIC VERIFICATION, US Patent Publication 005/0138392 A1; SECURE METHOD AND SYSTEM FOR COMPUTER PROTECTION, US Patent Publication 2004/0268322 A1; SECURE METHOD AND SYSTEM FOR HANDLING AND DISTRIBUTING DIGITAL MEDIA, US Patent Publication 2005/0021989-A1; SYSTEM AND METHOD FOR OBSCURING BIT-WISE AND TWO'S COMPLEMENT INTEGER COMPUTATIONS IN SOFTWARE, US Patent Publication 2005/0166191 A1; SYSTEM AND METHOD FOR PROTECTING COMPUTER SOFTWARE FROM A WHITE BOX ATTACK. US Patent Publication 2006/0140401-A1; SYSTEM AND METHOD FOR PROTECTING COMPUTER SOFTWARE FROM A WHITE BOX ATTACK, US Patent Publication 2004/0139340-A1; SYSTEM AND METHOD OF FOILING BUFFER-OVERFLOW AND ALIEN-CODE ATTACKS, US Patent Publication 003/0172293-A1; SYSTEM AND METHOD OF HIDING CRYPTOGRAPHIC PRIVATE KEYS, US Patent Publication 2005/0002532-A1; TAMPER RESISTANT SOFTWARE-CONTROL FLOW ENCODING, U.S. Pat. No. 6,779,114; TAMPER RESISTANT SOFTWARE ENCODING, U.S. Pat. No. 6,594,761; TAMPER RESISTANT SOFTWARE ENCODING, U.S. Pat. No. 6,842,862; TAMPER RESISTANT SOFTWARE-MASS DATA ENCODING, U.S. Pat. No. 7,350,085; the contents of which are all incorporated herein by reference in their entirety.

The implementation of a secure heap according to an embodiment of the present disclosure can be broken down into the following major components: (1) “core” implementation; (2) “handle” pointer implementation; (3) “stack-like” implementation; and (4) advanced features.

The “core” implementation is the basic implementation of a secure heap in accordance with the present disclosure. The core functionality provides a set of primitives to initialize the secure heap data-structures and allocate/free memory segments, which can be used to directly implement the basic “smooth” pointer secure heap APIs, or routines. At this point, the “stack-like” routines can be easily implemented based on the core functionality. Implementing the “handle” pointer routines involves providing a mechanism to map the handle-pointer to the actual allocation address within the secure heap, as well as implementing the handle-pointer access routines. At this point, all of the main secure heap routines are implemented, and the code may then undergo a period of security tuning to make sure that the routines and the underlying data structures are actually secure against attack. Finally, advanced features such as transformed/encoded heap contents, non-contiguous allocations, and mobile allocations, may be built on top of the basic handle-pointer functionality. The following sections describe each of the above components of the secure heap in accordance with embodiments of the present disclosure.

### Core Implementation

The secure heap “core” includes: code to initialize a secure heap memory segment, or secure heap object, within a previously allocated raw memory area; data-structures to maintain information about allocated and free memory segments within the secure heap; and code to support allocation/free requests. Other secure heap features in accordance with the present disclosure may be built up from the secure heap core functionality.

The secure heap library routines can be defined using the following parameters: (1) allocation policy: used to specify the nature of a new allocation, as regards its location in memory, such as “contiguous” and “non-contiguous”. For example, only the contiguous allocation policy is legal when a “smooth” pointer allocation is requested. (2) free policy: to specify what should be done to an allocated object when it is freed, or to the entire secure heap memory area at secure heap shutdown. For example, the free policy can indicate that an allocated object is zeroed, scrambled, or not zeroed, when freed. These parameters, shown as policy decisions 114 in FIG. 1, can be determined by the application programmer, or distributor. In addition, identifiers to reference a specific secure heap instance, and to reference an allocation object within a secure heap will need to be provided.

Embodiments of the secure heap library 106 itself can be implemented as a number of APIs, such as drop-in replacements for C/C++ stdlib APIs, while others provide new functionality, for example, support for non-contiguous array allocation. Users of the secure heap feature may rely on the transcoder 118 to automatically transform C/C++ style memory allocations into invocations of the secure heap library.

The secure heap library 106 of the present disclosure can be implemented as a “flexible” library, which defines the packaging of software into modules using an abstract intermediate representation. Such a flexible library can allow selection of security transformations and performance attributes to be made by the end-user (the integrating party), rather than the library creator. Furthermore, since the flexible library contains an abstract representation of the software modules, the library can also be provisioned to contain an arbitrary number of named “instances” representing specific sets of values for security and performance decisions, along with the corresponding native object-code resulting from those decisions. The collection of software modules can be packaged in the form of a flexible library that permits security transformations and performance optimizations to be chosen by the end-user rather than the creator of the software modules, and furthermore permits distribution of software modules in a completely platform-independent manner while avoiding the disclosure of proprietary information, such as source-files. A detailed description of flexible libraries can be found in PCT Application No. CA2010/000451 entitled, “METHOD FOR ENCAPSULATING AND ENABLING PROTECTION THROUGH DIVERSE VARIATIONS IN SOFTWARE LIBRARIES,” the contents of which are hereby incorporated by reference in their entirety.

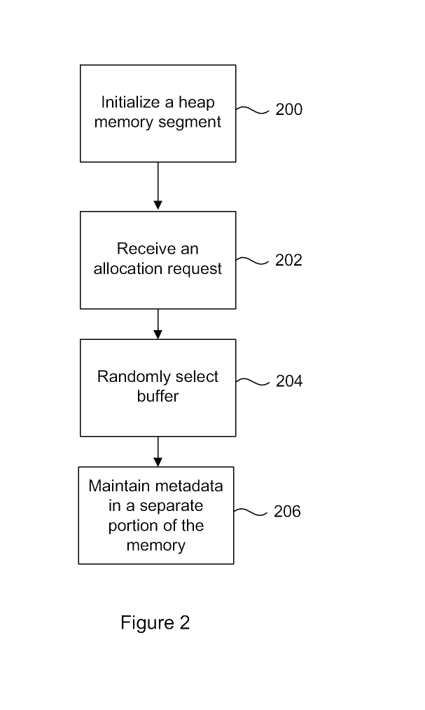

Generally, as shown in FIG. 2, the present method of dynamic memory management comprises initializing a heap memory segment, having a plurality of buffers, within a memory (step 200), such as a random access memory. When an allocation request to store data in the heap memory segment is received (step 202), one of the buffers is selected in a non-deterministic manner (step 204); typically in accordance with an allocation policy. Non-deterministic means that observation of a sequence of past output values (in this case, allocations) does not allow prediction of a specific future value. Non-deterministic allocations may be determined by a function returning purely random values (absolutely, under any known circumstances, unpredictable) or by a function returning pseudo-random values (unpredictable, unless possessed of a deep knowledge of the function's implementation and initial conditions). The terms “random” and “non-deterministic” are used interchangeably. Metadata, containing details of allocated and unallocated buffers of the heap memory segment, is then maintained in a portion of the memory separate from the heap object (step 206). Further details of the method, and the routines and data structures necessary to implement it, are described below.

According to an example embodiment, the secure heap 108 must reside in memory, such as allocated by the underlying stdlib heap implementation (or other user-specified memory area), and therefore requires a formal initialization routine. The C/C++ stdlib does not have formal initialization or shutdown routines for the memory allocation (heap) routines. Similarly, a shutdown routine must be provided to release the secure heap memory 108, with optional memory zeroing/scrambling.

The secure heap routines generally support allocations on a global, default, secure heap, or on an arbitrary secure heap specified by a handle parameter. Internally, the default secure heap is also referenced via a secure heap handle, which is stored in a secure heap library global object that has to be initialized. The initialization of the default secure heap handle must be performed by the programmer, since the size, location, and other attributes of the default secure heap must be determined, using a set default API. In the case of C++, where the invocation order of object initializers using the default secure heap may be difficult to determine, the programmer will be responsible for ensuring that the default secure heap is initialized before any attempt to perform allocations on it.

For example, the initialization routine can initialize a new secure heap with size sheapsize, using the platform-provided malloc( ), or using a memory-area provided by the caller. The routine returns a handle to the initialized secure heap if successful.

A shutdown routine performs shutdown of a secure heap instance. The memory area will be freed using the platform provided free( ) only if the secure heap was initialized with malloc( ); otherwise, it is the caller's responsibility to release the memory area using an appropriate shutdown routine. The shutdown routine can optionally perform zeroing or scrambling of the entire contents in accordance with the free policy parameter to indicate whether to zero or scramble, or entirely skip.

Examples of routines supported by the secure heap library 106 of the present disclosure are set out below. Note that most routines can come in two forms: one takes a secure heap handle parameter (described in greater detail below), and allows operations to be performed on a specific secure heap instance; the other form operates on the default secure heap instance, which is specially initialized by the application. The availability of the secure heap handle-parameter allows user-controllable support for thread-safe use of the secure heap, since each thread can simply initialize its own secure heap.

When using the default secure heap instance, a default allocation policy and a default free policy may also be used. These default policies may be updated by the programmer at any time using an appropriate routine, and take effect for all subsequent allocate/free requests. The APIs that take a secure heap handle parameter may also allow specification of a per-request allocation or free policy as an additional parameter.

As discussed above, traditional heap implementations are designed such that the execution overhead of allocation/free requests is minimized while heap utilization (the ratio of allocated to unused storage in a heap when a given allocation request cannot be serviced) is maximized. This typically results in a design in which the entire heap memory segment is treated as raw, unorganized storage, available for servicing any allocation request (up to and including a single request for the entire available heap memory), and where the allocation policy (how to decide which piece of unallocated storage to select for an allocation request) is the most important aspect of the implementation. However, such implementations typically suffer greatly from predictable memory allocation address vulnerability. The secure heap design according to certain embodiments of the present disclosure avoids, or at least reduces, this vulnerability by applying some organizational scheme to the memory segment at initialization time.

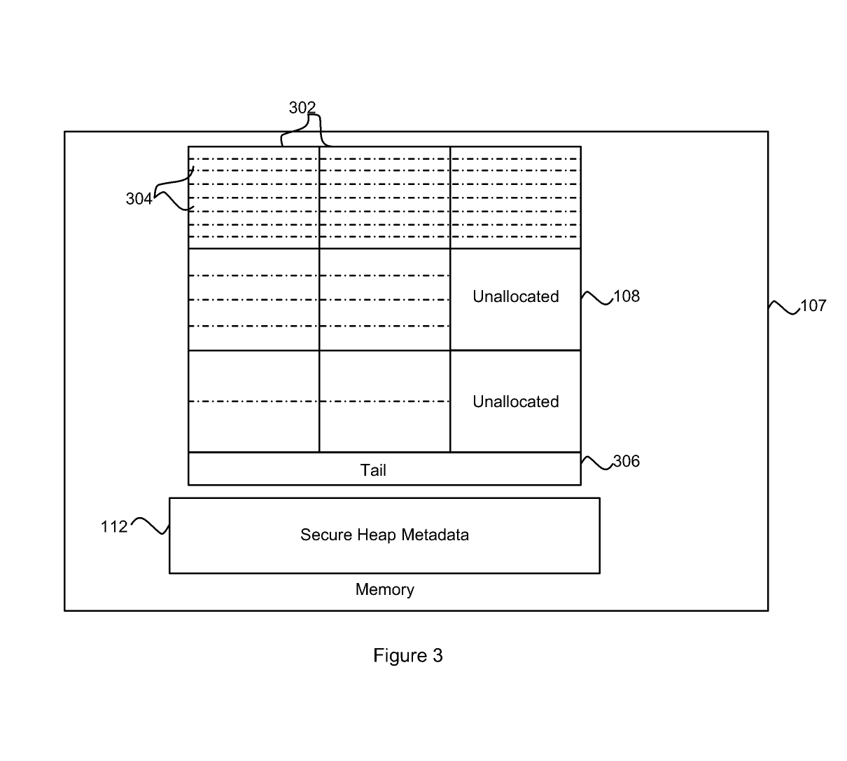

As shown in FIG. 3, sub-dividing the secure heap memory segment 108 into fixed-size pages 302, and using each as a form of sub-allocation for exactly one allocation size-class provides both performance (speed and avoidance of fragmentation), as well as improved security. According to certain embodiments of the present disclosure secure heap memory segment 108 is sub-divided into the maximum possible number of pages 302 of a fixed size. Depending on the number of pages 302 available (which in turn depends on the total size of the secure heap memory segment), a number of size-classes are reserved, with initially one page allocated to each size-class. The size-classes may be in a simple powers-of-two sequence, with a minimum of 16 bytes, and a maximum of ⅛th of the page-size. A number of pages may remain unbound to a size-class, and are then available for re-sizing, such as expansion, of existing size-classes as they become fully allocated.

Each page bound to a size-class will have a fixed number of potential allocations, or buffers 304. To avoid unnecessary fragmentation, allocation requests should preferably be satisfied by the page whose size-class is just greater than or equal to the request size. An allocation request results in the selection of some currently unallocated buffer within that page, but the exact choice of which address to allocate is made in a lightweight, stochastic (i.e random or pseudo-random) manner, so as to minimize the tendency to simply allocate the “next” buffer.

This memory organization provides a number of advantages, including: fragmentation within a size-class is bounded; the algorithm to select free memory to optimally satisfy an allocation request is straight-forward; it can dynamically load-balance number of pages devoted to each size-class based on allocation demand. In addition, certain advanced features may be supported by this memory organization. For example, non-contiguous allocations are straight-forward, since the non-contiguous allocations can be chosen to be exactly a size-class, and distributed across multiple pages bound to that size-class. A primitive form of low-overhead garbage collection can be performed by coalescing allocations of the same size-class from different pages into a single page, thus freeing up pages for re-use by other size-classes, and pages with an allocated size-class, but currently having no allocations, can be re-sized to another size-class, should the need arise.

The scheme for organizing the secure heap memory segment 108 involves a few low-level design details or policies which can have an impact on the performance and security aspects of the secure heap. For example, the following policies, relating to the physical layout of the secure heap memory segment 108, can be established: (1) selection of the page-size: in principal, page-sizes can be variable, but it simplifies the design considerably to choose a single, fixed page-size. According to an embodiment, the size is chosen to be sufficiently large to accommodate at least 16 buffers of the largest size-class; (2) alignment of the pages in the secure heap memory-segment: alignment of pages is preferred, as such alignment improves cache-memory performance, and also simplifies allocation routines, such as the secure heap valloc( ) routine; (3) selection of size-classes: any size-class can be supported, but according to an embodiment a minimum size-class is chosen, and subsequent size-classes are all powers-of-two of the minimum. For example, a minimum size-class of 16 bytes can be chosen (so that, for example, allocation requests of a single byte would be satisfied by the 16-byte size-class). The choice of a powers-of-two geometric sequence for the size-classes ensures that the buffers are always aligned in memory, which has performance benefits, as noted above; and (4) pre-allocation of size-classes: pages can be pre-allocated to size-classes at secure heap initialization, which results in reduced overhead at allocation-time. However, this can also result in wastage of pages if a given size-class is never used. A mix of pre-allocated and un-allocated pages provides the best performance/wastage tradeoff.

The following policies, relating to the design of the allocate/free logic, can also be provided: (1) selection criteria for “next” free page: the simplest policy is to maintain a list of free pages, and simply select the first available page for each allocation request. However, this introduces security concerns (i.e., predictable allocation patterns). A better policy is to maintain a randomly, or non-deterministically, generated permutation of all the pages, and use that permutation to search for free pages. At the expense of allocation-time overhead, this permutation can be occasionally re-generated to introduce further randomness to the allocation patterns; (2) selection criteria for “next” free buffer: the simplest policy is to maintain a list of free buffers within each page, and simply select the first available buffer for each allocation request. However, this introduces security concerns (i.e., predictable allocation patterns). A better policy is to maintain a randomly generated permutation of all the buffers in each page, and use that permutation to search for free buffers. At the expense of allocation-time overhead, this permutation can be occasionally re-generated to introduce further randomness to the allocation patterns; (3) promotion of un-allocated pages: pages with no associated size-class can be used to satisfy allocation requests that cannot otherwise be met by any other page; (4) scavenging of fully unused pages: once a page for a given size-class has no allocated buffers (all are free), either due to never having been used, or having all allocated buffers freed, the page can be scavenged, and returned to the pool of pages with no associated size-class; (5) allocation requests larger than the maximum size-class: either the policy can be that such requests are illegal, or attempts can be made to utilize the tail end 306 (see FIG. 3) of the secure heap memory segment (memory that has not been divided into pages), or the secure heap implementation can “fall through”, or revert, to a conventional heap implementation to satisfy the large request, though this may introduce security concerns.

As noted above, the secure heap metadata 112 describes the currently allocated memory and location of available (unallocated) memory within the secure heap. It also describes attributes of individual allocations, where appropriate, such as the presence of transformations/encodings, policies to be used on free, etc. According to an embodiment, one important attribute of the secure heap metadata 112 is that it not use the conventional heap implementation technique of putting information in the heap memory segment itself. For example, it is very common to identify each active allocation by putting the size of the allocation in the first few bytes of the buffer, and providing a pointer to the storage just after these bytes. This data is then used to tell the free operation how much memory to return to the free-list. Though this practice is very space-efficient, it introduces security vulnerabilities. Keeping the metadata 112 in completely isolated data-structures allows the metadata to be better protected against reverse-engineering.

Accordingly, embodiments of the present disclosure provide metadata data-structures to describe the following: (1) a list of all pages, and their current size-classes (if bound to one); (2) a map between class-sizes and the pages bound to that class-size; (3) for each page, a list of all currently unallocated buffers, preferably avoiding use of markers in the page-memory itself, since this is a security weakness; (4) for each active allocation, data describing the attributes of the allocation (this will also be used for such advanced features as non-contiguous allocations, transformed/encoded data, etc.).

A mechanism to map the allocation pointer (or “handle”, if that form of allocation was used) back to the allocation metadata is also provided. The secure heap manager can, for example, maintain a hash-map for “handle” pointers. In the case of “smooth” pointers, more primitive techniques can be used, since the address of the allocation directly states which page the allocation came from, and, from the page address, one can map back to the page metadata, revealing the class-size of the allocation.

According to an embodiment, the secure heap library can provide allocation/free routines that return “smooth” pointers (e.g. void *). These routines can be implemented as routines that are drop-in replacements for the C/C++ stdlib APIs they replace (i.e. malloc( ), calloc( ), realloc( ), valloc( ) and free( )). For example, a secure heap routine to replace malloc( ) will return a pointer to the allocated memory in the secure heap instance. Like malloc( ), it will take as a parameter the size of the requested allocation. In addition, the secure heap memory allocation routine may take as parameters the handle of the secure heap instance to be used for the allocation; and the allocation policy to be used. Other standard stdlib routines can be similarly modified.

### “Handle” Pointer Routines

According to an embodiment, the handle pointer allocation/free routines correspond directly to those for smooth pointer allocation/free routines, except that they return a secure heap allocation handle pointer instead of a void* pointer. The secure heap allocation handle is an “opaque” pointer, in that it does not directly map to a memory location. The opaque handle pointers may, for example, refer to storage that is not allocated contiguously, or may in fact be transformed pointers. As such, they cannot normally be de-referenced by the user, and require the use of special access routines in order to read/write the allocated storage. This limitation permits the allocated storage to be secured against attack utilizing techniques that would be impossible otherwise, such as encryption of content, non-contiguous allocation, and mobile allocations (i.e. time-varying allocations).

For example, the secure heap allocation-handle type can be a pointer to an anonymous data structure (the opaque pointer). This conceals all details of the underlying data-structure from the external user. The secure heap implementation can, for example, declare an actual data structure type for the opaque pointer. This simple implementation is still vulnerable to reverse-engineering, but more sophisticated techniques can be used, such as pointer transformation by the transcoder 118. According to an embodiment, the underlying allocation addresses can be mapped to a hash-value, and use this hash-value as the allocation-handle.

The “handle” pointer access routines can be used by application code when it wishes to read or write the contents of a secure heap allocation with no “smooth” pointer. Since the access routines are the only mechanism to reach the underlying, “raw” storage, the secure heap implementation is able to apply security techniques to these allocations that would otherwise be impossible, such as non-contiguous allocations, dynamic encodings, etc. These access routines should not impose undue overhead, as otherwise application code could experience dramatic slowdowns, such as, for example, when the allocated buffer is traversed in a loop, and simple arithmetic is performed on each element.

The access routines may be designed to support efficient application code, primarily through the use of the “memcpy” variants that copy a designated chunk of the underlying storage to a temporary buffer, allowing the application code to use traditional loop constructs without having to call an access routine for each element. Nonetheless, it is preferable to minimize the overhead of these access routines, such as by making use of inlining, etc.

In order to dereference opaque handle pointers, secure heap memory access routines are used. The routines can, for example, take as parameters one or more of the handle of the secure heap instance to be used for the allocation; a pointer to the value to be stored; the secure heap allocation handle of the object to be referenced; the element-size of the object; the index of the element to be returned; and a pointer to the user-specified buffer.

In one embodiment, only two basic types of memory access routines are provided: “load”/“store” operations and “memcpy”-style operations. According to this embodiment, the “load”/“store” secure heap memory access routines treat all allocations as arrays of objects with a user-specified element-size. As such, all the routines take both an element-size and an index. The total allocation size of all allocated objects is recorded in the secure heap metadata 112, which allows array-bounds checking to be performed on all accesses, since the element-size together with the index can be checked to be in-bounds. It may not be safe to use the pointer returned by the “load” operations to attempt to update the contents of an allocated object, since this pointer may in fact be a pointer to a temporary copy of the referenced element. In order to perform an “update” operation on a given secure heap memory location, the programmer would have to perform a separate “load” followed by a “store”.

The “memcpy”-style secure heap memory access routines allow bulk data to be copied to/from the secure heap allocation, and can be used to transfer data to/from the secure heap 108. Initialization of the contents of newly allocated secure heap memory would normally be performed with such a “memcpy” operation.

Since all updates to the contents of the allocated secure heap memory occur through the “load”/“store” and “memcpy” routines, it is possible to implement integrity verification of these allocations. Integrity verification can be performed automatically on every access to the secure heap allocation, or on user request. Since all legitimate modifications to the underlying secure heap memory buffer occur through the access routines, any attempt by an attacker to directly modify memory contents can be detected.

### “Smooth” Pointer Stack-like Routines

Stack-like routines that can be used to implement allocations related to local declarations, parameters, and any other object which would normally be allocated on the runtime stack, will now be described. The stack-like routines provide support for migrating data, such as C/C++ data, normally stored on the automatic stack to the secure heap 108.

This secure heap component requires support for a stack of frame-marker IDs that are created every-time a secure heap start-frame routine is called. The currently top-of-stack frame-ID is used to specially mark each allocation made with the frame-allocation routines, allowing them to be automatically freed upon calling a secure heap end-frame routine, which will also pop the framer-marker from the stack.

For traditional C stack allocations, the compiler automatically detects the start- and end-of-frame locations (basically, the beginning and end of lexical scopes). For the present method, the programmer must manually mark or indicate the start and end of the virtual “stack frame” in the default or specific secure heap instance by calls to appropriate start and end frame routines. Once the programmer has opened a new secure heap “stack frame”, stack-like allocations may be made as desired, all of which will be automatically freed upon reaching the next secure heap end frame call. The use of stack-like routines may be somewhat awkward when called directly, since the programmer will have to manually keep track of when to “pop” from the stack, or to release the “frame”, but they are quite useful for automatic insertion by the transcoder, or for use by writers of libraries.

In addition to providing a stack to maintain the frame-IDs as they are created and released, the data structure describing an active allocation can be extended to include a frame-ID. The automatic free of allocations upon release of a frame can be implemented by maintaining linked-lists for each frame-ID.

As an example, the secure heap library can provide stack-like routines equivalent to C/C++ stdlib APIs, such as alloca( ). For example, a secure heap allocation routine allocates the requested amount of storage in the current virtual “frame”, using the secure heap instance, and can be used to replace local-variable declarations. This is very similar to the stdlib alloca( ) routine, except that it uses the secure heap instead of the C-runtime stack. The secure heap allocation routine will return a pointer to the allocated memory in the secure heap instance. Like alloca( ), it will take as a parameter the size of the requested allocation. In addition, the secure heap memory allocation routine may take as parameters the handle of the secure heap instance to be used for the allocation; and the allocation policy to be used. To support subroutine parameters, the programmer can use a secure heap frame write routine on the calling side to copy data onto the stack (basically, a “push” operation), and a secure heap frame read routine on the callee side to copy data from the stack (basically, a “pop” operation). Other standard stdlib routines can be similarly modified.

### Advanced Features

The secure heap library 106 in accordance with certain embodiments of the present disclosure may also include routines to implement advanced features. One example of such a feature is non-contiguous array allocations. An array of a given size can be partitioned into an appropriate number of sub-elements of one of the size-classes, and these sub-elements can be chained together via an “array spine” (a data structure containing a pointer to each of the sub-elements). Such non-contiguous array allocations can only be used with the “handle” pointer allocation routines, as the returned memory is not a simple sequence of storage locations, and thus incompatible with the C/C++ definition of array storage. However, “handle” pointer access routines can be provided to allow users to read and write the storage of such non-contiguous allocations in a transparent manner.

A consideration for this feature is to provide a reasonably efficient mechanism for accessing data in a non-contiguous array, especially in a loop context. In cases where arithmetic is performed on each element of an array in a loop, especially where the access pattern is linear (simply walking through the array elements in order), the implementation should not impose excessive overhead due to the access routines. Other factors will affect performance, including interference with cache locality principals (the array elements no longer lie in contiguous memory, so cache performance is reduced).

Similarly to non-contiguous array allocations, further embodiments can include transformed/encoded allocations using the “handle” pointer allocation routines, and the secure heap allocation access routines. Secure heap library allocation data can be data-transformed or encrypted, and the encoding can even be time-varying. It may further be possible to implement allocations whose physical location in memory occasionally moves.

The more advanced features, such as the stack-like routines, and use of the “handle” pointer access routines, can be implemented using automatically generated code. Code generation, such as wbcodegen in the whitebox context as described in PCT Publication No. WO/2009/140774, entitled “SYSTEM AND METHOD FOR GENERATING WHITE-BOX IMPLEMENTATIONS OF SOFTWARE APPLICATIONS”, filed May 25, 2009, the contents of which are incorporated herein by reference in their entirety, can be used, but it should also be possible for the transcoder 118 to automatically code constructs that could usefully be transformed into secure heap API calls.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments of the invention are intended to be examples only. Alterations, modifications and variations can be effected to the particular embodiments by those of skill in the art without departing from the scope of the invention, which is defined solely by the claims appended hereto.

1. A computer-implemented method of dynamic memory management, the method comprising:
initializing a heap memory segment within a memory, the heap memory segment having a plurality of buffers;
receiving an allocation request to store data in the heap memory segment;
non-deterministically selecting at least one of the plurality of buffers satisfying the allocation request as an allocated buffer for the data; and
maintaining metadata relating to the allocated buffer in a portion of the memory separate from the heap memory segment.

2. The method of claim 1, further comprising associating the data to the non-deterministically selected buffer.

3. The method of claim 1, wherein initializing the heap memory segment comprises:
dividing the heap memory segment into a plurality of pages of fixed size.

4. The method of claim 3, wherein non-deterministically selecting the one of the plurality of buffers comprises:
generating a permutation of the plurality of pages; and
selecting a next free page from the permutation of the plurality of pages that satisfies the allocation request.

5. The method of claim 1, wherein non-deterministically selecting the one of the plurality of buffers comprises:
generating a permutation of the plurality of buffers; and
selecting a next free buffer from the permutation of the plurality of buffers that satisfies the allocation request.

6. The method of claim 1, wherein the metadata includes details of allocated and unallocated buffers of the heap memory segment.

7. The method of claim 6, wherein the details of allocated and unallocated buffers of the heap memory segment are used to implement integrity verification.

8. The method of claim 1, wherein the metadata includes a pointer to the allocated buffer.

9. The method of claim 8, wherein the pointer is an opaque pointer that cannot be directly de-referenced by the application.

10. The method of claim 1, wherein the metadata includes attributes of individual allocations.

11. The method of claim 10, wherein the attributes include details of security transformations applied to the data.

12. The method of claim 11, wherein the details of the security transformations applied to the data include encryption details.

13. The method of claim 1, further comprising:
receiving a free request to free one or more of the plurality of buffers; and
applying a free policy to the one or more of the plurality of buffers.

14. The method of claim 13, wherein the free policy determines whether to scramble or zero data in the one or more of the plurality of buffers.

15. A non-transitory computer-readable medium containing instructions, which when executed by a processor cause the processor to perform a method of dynamic memory management, the method comprising:
initializing a heap memory segment within a memory, the heap memory segment having a plurality of buffers;
receiving an allocation request to store data in the heap memory segment;
non-deterministically selecting at least one of the plurality of buffers satisfying the allocation request as an allocated buffer for the data;
associating the data to the non-deterministically selected buffer; and
maintaining metadata relating to the allocated buffer in a portion of the memory separate from the heap memory segment.

16. The computer-readable medium of claim 15, further comprising associating the data to the non-deterministically selected buffer

17. The computer-readable medium of claim 15, wherein initializing the heap memory segment comprises:
dividing the heap memory segment into a plurality of pages of fixed size.

18. The computer-readable medium of claim 17, wherein non-deterministically selecting the one of the plurality of buffers comprises:
generating a permutation of the plurality of pages; and
selecting a next free page from the permutation of the plurality of pages that satisfies the allocation request.

19. The computer-readable medium of claim 15, wherein non-deterministically selecting the one of the plurality of buffers comprises:
generating a permutation of the plurality of buffers; and
selecting a next free buffer from the permutation of the plurality of buffers that satisfies the allocation request.

20. The computer-readable medium of claim 15, wherein the metadata includes details of allocated and unallocated buffers of the heap memory segment.

21. The computer-readable medium of claim 20, wherein the details of allocated and unallocated buffers of the heap memory segment are used to implement integrity verification.

22. The computer-readable medium of claim 15, wherein the metadata includes a pointer to the allocated buffer.

23. The computer-readable medium of claim 22, wherein the pointer is an opaque pointer that cannot be directly de-referenced by the application.

24. The computer-readable medium of claim 15, wherein the metadata includes attributes of individual allocations.

25. The computer-readable medium of claim 24, wherein the attributes include details of security transformations applied to the data.

26. The computer-readable medium-readable medium of claim 25, wherein the details of the security transformations applied to the data include encryption details.

27. The computer-readable medium of claim 15, further comprising:
receiving a free request to free one or more of the plurality of buffers; and
applying a free policy to the one or more of the plurality of buffers.

28. The computer-readable medium of claim 27, wherein the free policy determines whether to scramble or zero data in the one or more of the plurality of buffers.

29. The computer-readable medium of claim 15, wherein the instructions are structured as a library.

30. The computer-readable medium of claim 29, wherein the library is a drop-in replacement for C/C++ stdlib library.
